(19) United States
(12) Patent Application Publication
(10) Pub. No.: US 2013/0290589 A1
(43) Pub. Date: Oct. 31, 2013

(54) TEST CIRCUIT FOR MEMORY MODULE

(71) Applicants: HONG FU JIN PRECISION INDUSTRY (ShenZhen) CO., LTD., (US); HON HAI PRECISION INDUSTRY CO., LTD., New Taipei (TW)

(72) Inventors: LEI LIU, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) Co., LTD., Shenzhen (CN)

(21) Appl. No.: 13/864,290

(22) Filed: Apr. 17, 2013

(30) Foreign Application Priority Data
Apr. 25, 2012 (CN) 201210123392.1

(51) Int. Cl. G06F 13/40

(52) U.S. Cl. CPC G06F 13/409
USPC 710/300

(57) ABSTRACT

A test circuit includes a power circuit module arranged on a motherboard of a computer and electrically coupled to first and second idle pins of a memory slot, and an indication module including a number of branch circuits. The indication module is arranged on a memory module. When the memory module is arranged in the memory slot properly, third idle pins of an edge connector of the memory module are electrically coupled to the first idle pins of the memory slot, respectively; and fourth idle pins of the edge connector of the memory module are electrically coupled to the second idle pins of the memory slot, respectively.

### BACKGROUND

1. Technical Field

The present disclosure relates to a test circuit for a memory module.

2. Description of Related Art

With the cost of memory modules decreasing, more and more memory modules are used in computers. When installing an additional memory module in a computer, a power plug of the computer should be disconnected, and then the computer is opened and the memory module is installed in a memory slot of the motherboard. After the memory module is installed, the computer is closed and started up to test whether the installed memory module is working properly. If the computer indicates any problems, then the process is repeated, which is inconvenient and time-consuming.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is an isometric view of a plurality of memory modules arranged in corresponding memory slots.

FIG. 2 is a circuit diagram of a test circuit for testing the memory modules of FIG. 1.

### DETAILED DESCRIPTION

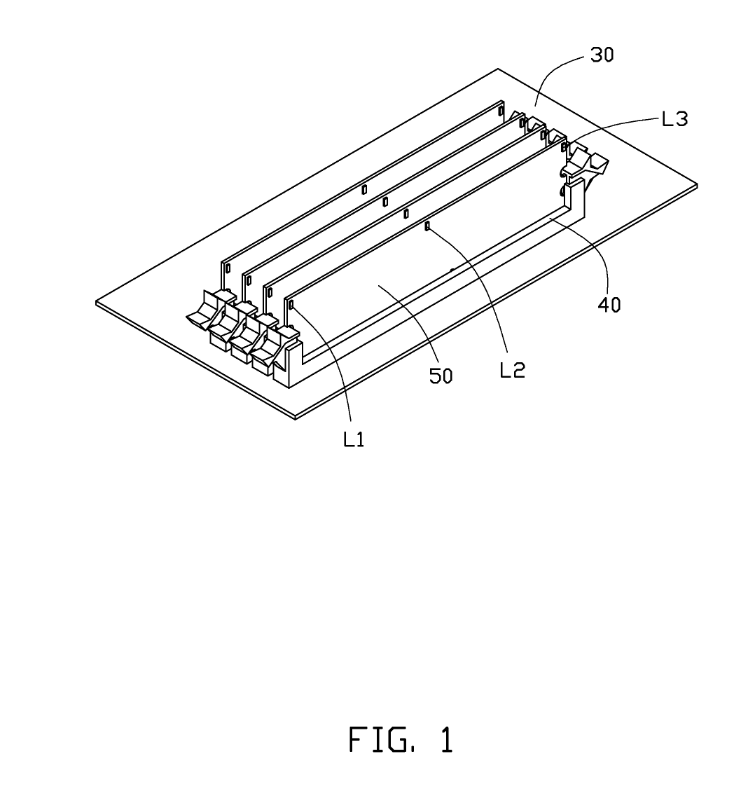

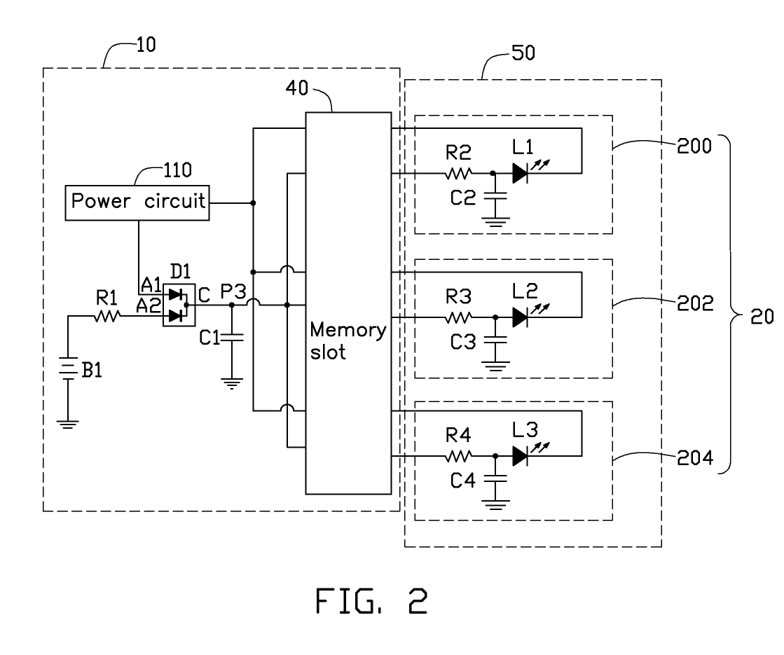

FIG. 1 shows a plurality of memory modules 50 arranged in corresponding memory slots 40. FIG. 2 shows a test circuit of an exemplary embodiment of the present disclosure for testing whether pins of the memory modules 50 are properly coupled to corresponding pins of the memory slots 40.

Each memory slot includes a plurality of grounded idle pins, and may predefine a plurality of first idle pins.

The test circuit includes a power circuit module 10 including the memory slots 40 and a plurality of memory modules including an indication module 20 for each memory module 50. The power circuit module 10 is arranged on a motherboard 30 comprising the memory slots 40, and electrically coupled to the first idle pins and the plurality of grounded idle pins of the memory slots 40. The indication modules 20 are arranged on the memory modules 50, and each is electrically coupled to a plurality of second idle pins of an edge connector of the corresponding memory module 50, the second idle pins corresponding to the first idle pins of the memory slot 40. When one of the memory modules 50 is arranged in one of the memory slots 40, the indication module 20 emits light if the second idle pins of the memory modules 50 are properly electrically coupled to the first idle pins of the memory slot 40.

The power circuit module 10 includes a power circuit 110, a battery B1, a resistor R1, a capacitor C1, and a Schottky diode D1. A first anode of the Schottky diode D1 is coupled to the power circuit 110. A second anode of the Schottky diode D1 is coupled to a positive pole of the battery B1. A cathode of the Schottky diode D1 is grounded through the capacitor C1. A negative pole of the battery B1 is grounded. A node P3 between the cathode of the Schottky diode D1 and the capacitor C1 functions as a power terminal to provide power for the first idle pins of the memory slot 40. Ground terminals of the power circuit 110 are coupled to the plurality of grounded idle pins of the memory slot 40.

When the power circuit 110 accesses an external power source, such as alternating current power source, power for the node P3 is provided by the power circuit 110. Otherwise, power for the node P3 is provided by the battery B1.

The indication module 20 includes a plurality of branch circuits. Each branch circuit includes a power terminal and a ground terminal. Each power terminal is coupled to one of the second idle pins of the memory modules 50. Each ground terminal is coupled to a ground idle pin of the memory modules 50. In this embodiment, the indication module 20 includes first to third branch circuits 200, 202, and 204.

The first branch circuit 200 includes a resistor R2, a light-emitting diode (LED) L1, and a capacitor C2. A first end of the resistor R2 functions as the power terminal. A second end of the resistor R2 is coupled to an anode of the LED L1. A cathode of the LED L1 functions as the ground terminal of the first branch circuit 200. The anode of the LED L1 is grounded through the capacitor C2.

The second branch circuit 202 includes a resistor R3, an LED L2, and a capacitor C3. A first end of the resistor R3 functions as the power terminal. A second end of the resistor R3 is coupled to an anode of the LED L2. A cathode of the LED L2 functions as the ground terminal of the second branch circuit 203. The anode of the LED L3 is grounded through the capacitor C3.

The third branch circuit 203 includes a resistor R4, an LED L3, and a capacitor C4. A first end of the resistor R4 functions as the power terminal. A second end of the resistor R4 is coupled to an anode of the LED L3. A cathode of the LED L3 functions as the ground terminal of the third branch circuit 204. The anode of the LED L3 is grounded through the capacitor C4.

When one of the memory modules 50 is arranged in one of the memory slots 40, the second idle pins are respectively electrically coupled to the first idle pins of the memory slot 40, thus electrically coupling the power terminals of the first to third branch circuits 200, 202, and 204 to the node P3 of the power circuit module 10. The ground idle pins of the memory module 50 are respectively electrically coupled to the grounded idle pins of the corresponding memory slot 40, thus electrically coupling the ground terminals of the first to third branch circuits 200, 202, and 204 to the ground terminals of the power circuit module 10. When the power circuit module 10 is disconnected from the external power source, the power for the node P3 is provided by the battery B1. If the pins of the memory module 50 are all coupled to the corresponding pins of the memory slots 40, the LEDs L1-L3 emit light. If one or more pins of the memory module 50 are not coupled to the corresponding pin of the memory slot 40, at least one of the LEDs L1-L3 will not emit light. Accordingly, it is convenient for the user to know whether the memory module 50 is properly installed in the memory slot 40.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A test circuit, comprising:
a power circuit module arranged on a motherboard of a computer comprising a memory slot, the power circuit module comprising a first power terminal coupled to a plurality of first idle pins of the memory slot, and a first ground terminal coupled to a plurality of second idle pins of the memory slot; and
a memory module comprising an indication module, wherein the indication module comprises a plurality of branch circuits, each branch circuit comprises a second power terminal and a second ground terminal, the second power terminal of each branch circuit is coupled to one of a plurality of third idle pins of an edge connector of the memory module, and the second ground terminal of each branch circuit is coupled to one of a plurality of grounded fourth idle pins of the edge connector of the memory module, an indication element is arranged between the second power terminal and the second ground terminal of each branch circuit;
wherein when the memory module is arranged in the memory slot, the plurality of third idle pins of the memory module are coupled to the plurality of first idle pins of the memory slot, respectively; and the plurality of fourth idle pins of the memory module are coupled to the plurality of second idle pins of the memory slot, respectively; the indication elements of the branch circuits display indication information indicating status of the memory module in the memory slot.

2. The test circuit of claim 1, wherein the indication element of each branch circuit is a light-emitting diode (LED), an anode of the LED is coupled to the second power terminal of the branch circuit, and a cathode of the LED is coupled to the second ground terminal of the branch circuit.

3. The test circuit of claim 2, wherein each branch circuit further comprises a resistor, the resistor is coupled between the second power terminal of the branch circuit and the anode of the LED.

4. The test circuit of claim 3, wherein each branch circuit further comprises a capacitor, the capacitor is coupled between the second ground terminal of the branch circuit and the anode of the LED.

5. The test circuit of claim 1, wherein the power circuit module comprises a Schottky diode, a power circuit, and a battery, a first anode of the Schottky diode is coupled to the power circuit, a second anode of the Schottky diode is coupled to a positive pole of the battery, a negative pole of the battery is grounded, a cathode of the Schottky diode is coupled to the first power terminal of the power circuit module, ground pins of the memory slot are coupled to the first ground terminal of the power circuit module, when the power circuit accesses an external power source, the power for the first power terminal is provided by the external power source, the power for the first power terminal is provided by the battery in response to the external power source being disconnected from the power circuit.

6. The test circuit of claim 5, wherein the power circuit module further comprises a resistor and a capacitor, the second anode of the Schottky diode is coupled to the positive pole of the battery through the resistor, the cathode of the Schottky diode is grounded through the capacitor.
